(19) United States
(12) Patent Application Publication
(10) Pub. No.: US 2015/0254424 A1
(43) Pub. Date: Sep. 10, 2015

(54) SYSTEM AND APPARATUS FOR IMPROVING MEDICATION REGIMEN ADHERENCE

(71) Applicant: Xerox Corporation, Norwalk, CT (US)

(72) Inventor: Peter J. Zehler, Penfield, NY (US)

(73) Assignee: Xerox Corporation, Norwalk, CT (US)

(21) Appl. No.: 14/197,928

(22) Filed: Mar. 5, 2014

(51) Int. Cl. G06F 19/00; H04W 76/02

(52) U.S. Cl. CPC G06F 19/3456; H04W 76/021

(57) ABSTRACT

A computer-based system for improving medication regimen adherence, including: a container arranged to hold a first medication and including a wireless transceiver and a unique identifier; and a wireless communications device (WCD) including: a memory element configured to store a medication regimen including a prescription for the medication and the unique identifier, the unique identifier associated with the medication regimen; and a processor configured to when the container is within a predetermined distance of the WCD obtain, via the wireless transceiver, the unique identifier from the container, confirm that the unique identifier from the container matches the unique identifier stored in the memory element, obtain data from the container regarding instances of the container being opened, determine, according to the data and the medication regimen, that a reminder to take the medication is desired, and output a sensory reminder signal.

### TECHNICAL FIELD

The present disclosure relates to a system and apparatus for improving medication regimen adherence, in particular a system and apparatus for using a wireless communications device to provide reminders based on proximity to a medication container having wireless communication capability and providing data regarding a condition related to access to the container.

### BACKGROUND

Medication adherence, including patient adherence to medication regimens is an important aspect of any system providing medical services. Specifically, lack of medical adherence has a negative effect on outcomes and increases costs associated with providing medical services.

It is know to use a “smart” pillbox incorporating a timer, reminder lights and sounds, and ability to sense that pills have been removed from the pillbox. Some such pillboxes also record adherence, and can notify a caregiver if too much time elapses or too many doses are missed. Similarly, medication reminder apps for mobile devices are known. However, known systems and devices do not provide for dynamic communication between a pillbox or similar device and a mobile device. The preceding lack of flexibility and dynamic capability adversely impacts adherence.

### SUMMARY

According to aspects illustrated herein, there is provided a computer-based system for improving medication regimen adherence, including a first computer including: a first memory element configured to store a first medication regimen including a first prescription for a first medication and a first unique identifier associated with the first medication regimen; and a first processor. The system includes: a first container arranged to hold the first medication and including a first wireless transceiver and the first unique identifier; and a first wireless communications device (WCD) including a second memory element and a second processor configured to when the first container is within a first predetermined distance of the first WCD obtain, via the first wireless transceiver, the first unique identifier from the first container and transmit, to the first computer, the first unique identifier obtained from the first container. The first processor is configured to: confirm that the first unique identifier from the first container matches the first unique identifier stored in the first memory element; and transmit the first medication regimen to the first WCD. The second processor is configured to store the first medication regimen in the second memory element.

According to aspects illustrated herein, there is provided a computer-based system for improving medication regimen adherence, including: a container arranged to hold a first medication and including a wireless transceiver and a unique identifier; and a wireless communications device (WCD) including: a memory element configured to store a medication regimen including a prescription for the medication and the unique identifier, the unique identifier associated with the medication regimen; and a processor configured to when the container is within a predetermined distance of the WCD obtain, via the wireless transceiver, the unique identifier from the container, confirm that the unique identifier from the container matches the unique identifier stored in the memory element, obtain data from the container regarding instances of the container being opened, determine, according to the data and the medication regimen, that a reminder to take the medication is desired, and output a sensory reminder signal.

According to aspects illustrated herein, there is provided a container for improving medication regimen adherence, including: a body portion arranged to store a medication; a sensor configured to detect a condition associated with accessing contents of the body portion; a wireless transceiver; and a processor configured to create data regarding identification of the condition and when the container is within a predetermined distance of a specially programmed wireless communications device (WCD), transmit the data to the WCD.

According to aspects illustrated herein, there is provided a wireless communications device (WCD) for improving medication regimen adherence, including: a memory element; and a processor configured to when the WCD is within a predetermined distance of a container including a wireless transceiver receive, via the wireless transceiver, a unique identifier from the container, transmit the unique identifier to a second computer, receive, from the second computer, a medication regimen including a prescription for a medication and store the medication regimen in the memory element.

According to aspects illustrated herein, there is provided a computer-based method for improving medication regimen adherence, including: storing in a first memory element for a first computer a medication regimen including a prescription for a medication and a unique identifier associated with the medication regimen; when a container is within a predetermined distance of a wireless communications device (WCD) obtaining, using a first processor for the WCD and via a wireless transceiver for the container, the unique identifier from the container; transmitting, using the first processor, the unique identifier obtained from the container to the first computer; confirming, using a second processor for the first computer, that the unique identifier from the container matches the unique identifier stored in the first memory element; transmitting, using the second processor, the medication regimen to the WCD; and storing the medication regimen in the second memory element.

According to aspects illustrated herein, there is provided a computer-based method for improving medication regimen adherence, including: storing in a memory element of a wireless communications device (WCD) a medication regimen including a prescription for the medication and a unique identifier, the unique identifier associated with the medication regimen; when the container is within a predetermined distance of the WCD: obtaining, using a processor for the WCS and via the wireless transceiver, a unique identifier from the container; confirming, using the processor, that the unique identifier from the container matches the unique identifier stored in the memory element; obtaining, using the processor, data from the container regarding instances of the container being opened; determining, using the processor and according to the data and the medication regimen, that a reminder to take the medication is desired; and outputting, using the processor, a sensory reminder signal.

According to aspects illustrated herein, there is provided a computer-based method for improving medication regimen adherence, including: detecting, using a sensor for a container, a condition associated with accessing contents of the body portion; creating, using a processor for the container, data regarding identification of the condition; and when the container is within a predetermined distance of a specially programmed wireless communications device (WCD), transmitting, via a wireless transmitter for the container, the data to the WCD.

According to aspects illustrated herein, there is provided a computer-based method for improving medication regimen adherence, including: when a WCD is within a predetermined distance of a container including a wireless transceiver, receiving, using a processor for the WCD and via a wireless transceiver for the container, a unique identifier from the container; transmitting, using the processor, the unique identifier to a computer; receiving, using the processor and from the second computer, a medication regimen including a prescription for a medication; and storing, in a memory element for the WCD, the medication regimen.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic diagram of a container for improving medication regimen adherence;

FIG. 2 is a schematic functional diagram of the container shown in FIG. 1 showing example sensors;

FIG. 3 is a schematic block diagram of a wireless communications device for improving medication regimen adherence;

FIG. 4 is a schematic block diagram of a computer-based system for improving medication regimen adherence;

FIG. 5 is a schematic flow diagram of the system in FIG. 4;

FIG. 6 is a schematic block diagram of a system, for improving medication regimen adherence, with multiple containers; and,

FIG. 7 is a schematic block diagram of a system, for improving medication regimen adherence, with multiple wireless communications devices.

### DETAILED DESCRIPTION

Moreover, although any methods, devices or materials similar or equivalent to those described herein can be used in the practice or testing of these embodiments, some embodiments of methods, devices, and materials are now described.

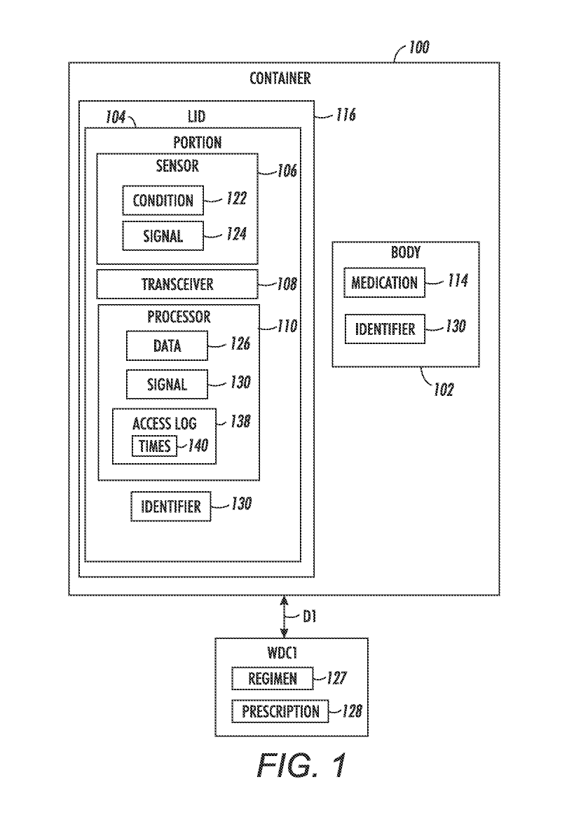

FIG. 1 is a schematic block diagram of container 100 for improving medication regimen adherence.

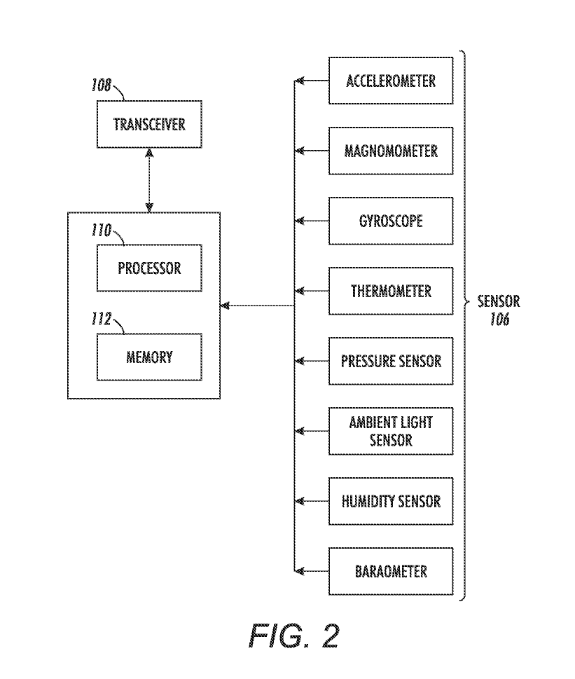

FIG. 2 is a schematic functional diagram of container 100 shown in FIG. 1 showing example sensors. The following should be viewed in light of FIGS. 1 and 2. Container 100 includes body portion 102 and computational portion 104. Portion 104 includes sensor 106, wireless transceiver 108, and processor 110. Portion 102 is arranged to hold medication 114. Portion 104 can be included in lid 116, in portion 102, or can be divided between portion 102 and lid 116. In the example of FIG. 1, portion 104 is included in lid 116.

Sensor 106 is configured to detect condition 122 associated with accessing contents of body portion 102 (for example removing lid 116) and create detection signal 124 indicating detection of condition 122. Processor 110 is configured to receive signal 124 and create, using signal 124, data 126 identifying when condition 122 has been detected. When container 100 is within predetermined distance D1 of wireless communications device WCD1 storing regimen 127 including prescription 128 for medication 114, processor 110 is configured to transmit data 126 to WCD1.

Container 100 includes globally unique identifier 130. When WCD1 is within distance D1 of container 100, transceiver 108 is arranged to transmit identifier 130 to WCD1 for purposes of identification and confirmation. For example, data 126 is not transmitted until the identification and confirmation process is completed. Identifier 130 can be located on body 102 or lid 116. Further details regarding identifier 130 and the identification and confirmation process are provided below.

By “regimen” we mean an overall program for improving health through the use of a medication. The program can include goals, instructions, and directives. The instructions or directives can include dosages, times for taking dosages, and related information such as keying the taking of the medication to other events or conditions. By “prescription” we mean instructions from an authorized health care provider to provide a prescription medication to a patient that is not legally available to the patient without the prescription. A prescription typically includes at least some of the instructions or directives noted above.

Sensor 104 can be any sensor known in the art. Example sensor types are shown in FIG. 2. Processor 110 and memory element 112 can be any processor or memory element, respectively, known in the art.

By “wireless transceiver” we mean any device known in the art capable of transmitting and receiving wireless signals, for example radio frequency signals. By “wireless communications device” we mean a communications device that transmits and receives communications signals via a non-wired medium, such as radio frequency. Wireless communications devices can include, but are not limited to AM or FM radio devices, cellular phones, portable phones, and devices, such as laptop computers and personal digital assistants (PDAs) interfaced with a wireless network, for example, a local area network (LAN) or a wide area network (WAN). Applicable formats, standards or protocols, include, but are not limited to, Ethernet (or IEEE 802.3), SAP, ATP, Bluetooth, and TCP/IP, TDMA, CDMA, and 3G.

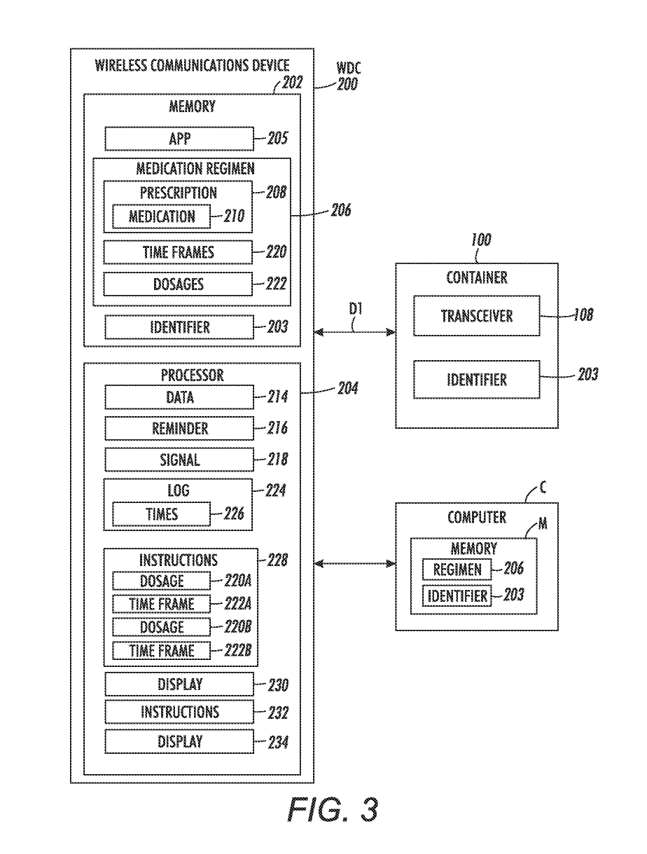

FIG. 3 is a schematic block diagram of wireless communications device WCD 200 for improving medication regimen adherence. WCD 200 includes memory element 202 and processor 204. Memory element 202 is configured to store computer readable instructions (application) 205 with instructions for executing the operations described below. When WCD 200 is within predetermined distance D1 of container 100 including wireless transceiver 108, WCD 200 is configured to receive, via wireless transceiver 108, unique identifier 203 from the container. Processor 204 is configured to transmit unique identifier 203 to computer C including memory element M storing identifier 203 and medication regimen 206 including prescription 208 for medication 210. For example, computer C is operated by an entity coordinating health care providers prescribing medication 210 or otherwise involved in the care of a patient taking medication 210, medication providers, or an entity, such as an insurance company, paying for medication 210 or health care related to a patient taking medication 210. Processor 204 is configured to receive, from computer C, regimen 206 and store regimen 206 in memory 202. Processor 204 also is configured to store identifier 203 in memory 202. As further described below, computer C performs a verification process regarding identifier 203 to confirm that regimen 206 is applicable to container 100.

Processor 204 is configured to obtain data 214 from the container and determine, according to data 214 and medication regimen 206, that reminder 216 to take medication 210 is desired. Processor 204 then outputs sensory reminder signal 218. In an example embodiment, processor 204 is configured to transmit data 214 to computer C.

In an example embodiment, medication regimen 208 includes time frames 220 within which to access the container to obtain dosages 222 of medication 210 and processor 204 is configured to determine, according to time frames 220, that reminder 216 is desired. In an example embodiment, data 214 includes access log 224 identifying respective times 226 associated with opening the container.

In an example embodiment, time frames 220 includes time frame 220A within which to access the container to obtain dosage 222A of medication 210. Processor 204 is configured to determine, using access log 224, that the container has not been accessed within a time frame 220A and create instructions 228 to take dosage 222A within time frame 220B, different from time frame 220A, or take dosage 222B, different from dosage 222A, within time frame 220B. Processor 204 is configured to provide sensory display 230 of instructions 228. A sensory display includes any visual, audio, or tactile expression known in the art.

In an example embodiment, time frames 220 includes time frame 220A within which to access the container to obtain dosage 222A of medication 210. Processor 204 is configured to determine that the container is not within distance D1 of WCD 200 during time frame 220A for taking dosage 222A (thus, medication 210 has not been obtained from the container within time frame 220A). Processor 204 is configured to create instructions 232 to take an action including, but not limited to contacting a health care provider, modifying diet or physical activity, or modifying another medical regimen for another medication. That is, instructions 232 address possible ill effects of not taking medication 210 according to regimen 206. Processor 204 is configured to provide sensory display 234 of instructions 232. When the container is within distance D1 of WCD 200, processor 204 is configured to create instructions 228 and display 230 as needed.

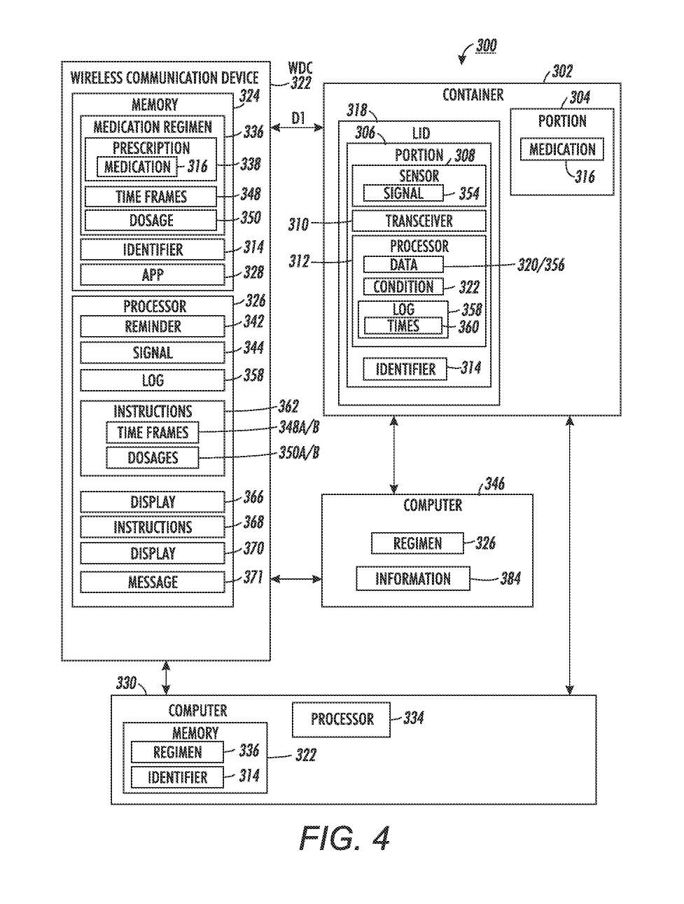

FIG. 4 is a schematic block diagram of computer-based system 300 for improving medication regimen adherence.

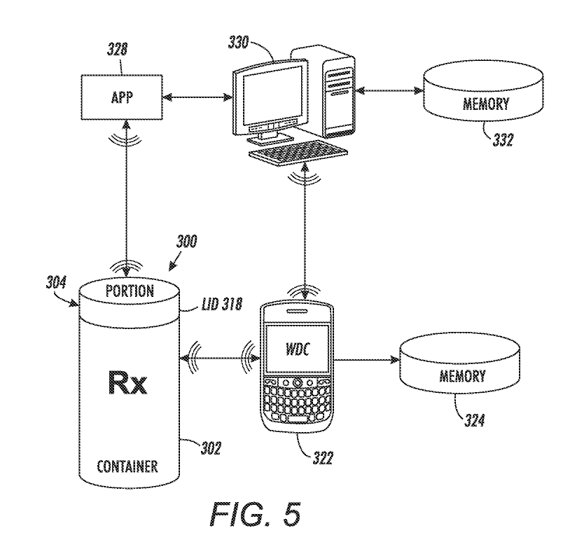

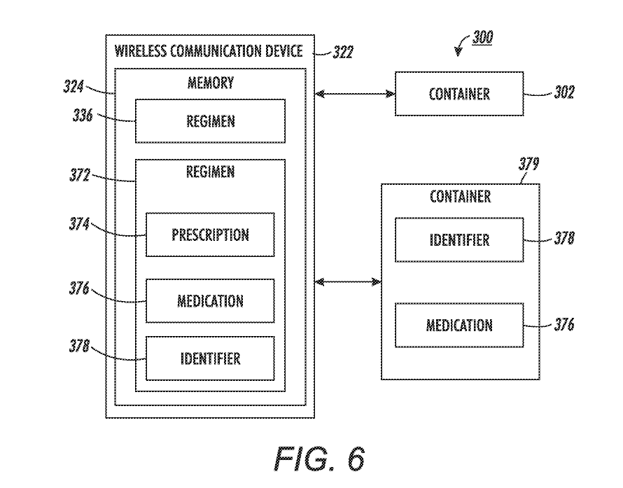

FIG. 5 is a schematic flow diagram of system 300 in FIG. 6. System 300 includes container 302 including body portion 304 and computational portion 306. Portion 306 includes sensor 308, wireless transceiver 310, processor 312, and unique identifier 314. Portion 304 is arranged to hold medication 316. Portion 306 can be included in lid 318, in portion 304, or can be divided between portion 304 and lid 318. In the example of FIG. 4, portion 306 is included in lid 318. The discussion regarding sensor 104 is applicable to sensor 308. Processor 312 is configured to create data 320 identifying condition 322 associated with opening container 302 as further described below.

System 300 includes wireless communications device WCD 322 including memory element 324 and processor 326. Memory element 324 is configured to store computer readable instructions (application) 328 with instructions for executing the operations described below. System 300 includes service computer 330 used to coordinate operations in system 300. For example, computer 330 is operated by an entity coordinating health care providers prescribing medication 316 or otherwise involved in the care of a patient taking medication 316, medication providers, or an entity, such as an insurance company, paying for medication 316 or health care related to a patient taking medication 316. Computer 330 includes memory element 332 and processor 334. Memory element 332 is configured to store unique identifier 314 and medication regimen 336 including prescription 338 for medication 316.

When container 302 is within predetermined distance D1 of WCD 322, processor 326 is configured to communicate with processor 312, via wireless transceiver 310, to obtain identifier 314. Processor 326 is configured to transmit, to computer 330, unique identifier 314 obtained from container 302. Processor 334 is configured to compare identifier 314 from container 302 with identifier 314 stored in memory element 332 to confirm that identifier 314 from container 302 matches identifier 314 stored in memory element 332. When the confirmation is made, processor 334 is configured to transmit medication regimen 336 to WCD 322 and processor 326 is configured to store medication regimen 336 and identifier 314 in memory element 324.

After receipt of medication regimen 336 and identifier 314 and while container 302 is within distance D1 of WCD 322, processor 326 is configured to obtain data 320 from container 302 and determine, according to data 320 and medication regimen 336, that reminder 342 to take medication 316 is desired. Processor 326 is configured to output sensory reminder signal 344. Signal 344 can be any graphical, tactile, or auditory signal known in the art. In an example embodiment, processor 326 is configured to transmit data 320 to computer 330. In an example embodiment, system 300 includes computer 346 associated with a health care provider providing the first prescription or otherwise involved in care of the patient for whom medication 316 is prescribed, and processor 326 is configured to transmit data 320 to computer 346.

Once identifier 314 and regimen 336 are stored in memory 324, each time container 302 comes within distance D1 of WCD 322, WCD 322 obtains identifier 314 from container 302 to confirm the identity of the container and the interactions described above and below between container 302 and WCD 322 are implemented as needed.

In an example embodiment, medication regimen 336 includes time frames 348 within which to access container 302 to obtain a dosage 350 of the medication 316. Processor 326 is configured to determine, according to time frames 348, that reminder 342 is desired.

Sensor 308 is configured to detect condition 322 and create detection signal 354 indicating detection of condition 322. Processor 312 is configured to receive signal 354 and create, using signal 354, data 356 identifying when condition 322 has been detected. In an example embodiment, data 356 is included in data 320.

In an example embodiment, sensor 308 is configured to send a respective detection signal 354 to processor 312 for each detected occurrence of condition 322 and processor 312 is configured to create access log 358 including a respective time 360 at which each respective detection signal 354 is received by processor 312. In an example embodiment, data 320 includes access log 358. In an example embodiment, processor 326 is configured to transmit log 358 to computer 330 and/or computer 346.

In an example embodiment, time frames 348 includes time frame 348A within which to access container 302 to obtain dosage 350A of medication 316. Processor 326 is configured to determine, using access log 358, that the container has not been accessed within time frame 348A and create instructions 362 to take dosage 348A within time frame 350B, different from time frame 348A, or take dosage 348B, different from dosage 348A, within time frame 350B. Processor 326 is configured to provide sensory display 366 of instructions 362. A sensory display includes any visual, audio, or tactile expression known in the art.

In an example embodiment, time frames 348 includes time frame 348A within which to access container 302 to obtain dosage 350A of medication 316. Processor 326 is configured to determine that container 302 is not within distance D1 of WCD 322 during time frame 348A for taking dosage 350A (thus, medication 316 has not been obtained from the container within time frame 350A). Processor 326 is configured to create instructions 368 to take an action including, but not limited to, contacting a health care provider, modifying diet or physical activity, and modifying another medical regimen for another medication. That is, instructions 368 address possible ill effects of not taking medication 316 according to regimen 336. Processor 326 is configured to provide sensory display 370 of instructions 368. When the container is within distance D1 of WCD 200, processor 326 is configured to create instructions 362 and display 366 as required.

In an example embodiment, processor 326 is configured to transmit message 371 to computer 334 and/or computer 346. Message 372 provides information regarding creation of instructions 362 and/or 368, for example, to alert health care providers and to update medical records.

In an example embodiment, computer 330 is configured to receive regimen 336 from computer 346.

FIG. 6 is a schematic block diagram of system 300 for improving medication regimen adherence with multiple containers. In an example embodiment, memory 324 in WCD 322 is configured to store regimen 372 with prescription 374 for medications 376 as well as medication regimen 336. Memory element 324 also is configured to store unique identifier 378 associated with regimen 372. In addition to container 302, system 300 includes container 379 arranged to store medication 376 and including unique identifier 378. The discussion above regarding WCD 322 and container 302 is applicable to the interaction of WCD 322 with container 378. Although two containers are shown in FIG. 6, it should be understood that WCD 322 can store any number of medication regimens and interact with any number of respective containers arranged to store respective appropriate medications and configured to store respective appropriate medication regimens.

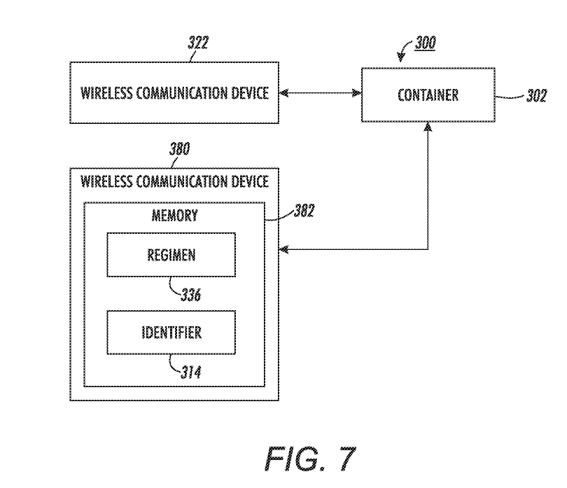

FIG. 7 is a schematic block diagram of system 300 for improving medication regimen adherence with multiple WCDs. In an example embodiment, system 300 includes WCD 322 and WCD 380 with memory element 382 configured to store medication regimen 336 and identifier 314. The discussion above regarding WCD 322 and container 302 is applicable to the interaction of WCD 380 with container 302. Although two WCDs are shown in FIG. 9, it should be understood that any number of WCDs can store regimen 336 and interface with container 302.

Advantageously, container 100, WCD 200, and system 300 provide the flexibility and dynamic interaction lacking in known medication dispensing apparatus. The discussion that follows is directed to system 300; however, it should be understood that the discussions regarding container 302 and WCD 322 are applicable to container 100 and WCD 200, respectively. As noted above, container 302 has on-board intelligence and wireless communications capabilities and includes a globally unique identifier, at least one sensor capable of detecting when the container is accessed, and memory to record access events.

Advantageously, container 100, WCD 200, and system 300 maintain the confidentiality of personal identifiable patient information while enabling the dynamic interaction noted above. For example, no personal identifiable patient information is stored by container 100 or 302. Only the unique identifier and the access log are stored on the container. Personal identifiable patient information is securely stored in WCD1, WCD 200, and WDC 322. Personal identifiable patient information is not made available during transmissions between containers 100 and 302 and the respective WCDs; for example, all such transmissions are encrypted. WCD1, WCD 200, and WDC 322 only transfer personal identifiable patient information to trusted, authenticated, and authorized entities such as those entities associated with computer 330 or computer 346.

In an example embodiment, when medication 316 is placed in container 302, the container, medication, regimen, patient identification and other metadata is registered with the entity operating computer 330. Container 302 and WCD 322 are linked together and with computer 334. Container 302 synchronizes log 358 with WCD 322 whenever WCD 322 is within a specified range of container 302. WCD 322 uses information from the log and the proximity to container 302 to provide relevant reminders to the patient. WCD 322 also communicates with computers 330 and 346 to provide information regarding compliance with the medication regimen.

The following is an example sequence of operation for system 300:

1. Application 328 is installed on WCD 322 and configured to communicate with service computer 330.

2. Regimen 336 and patient information 384 are obtained from computer 346 by computer 330

3. Medication 316 is placed in container 302 and identifier 314 is associated with container 302.

4. Identifier 314, information 384, and other patient information, and metadata are registered with computer 330 and stored in memory 332.

5. The patient obtains container 302.

6. WCD 322, via application 328, detects container 302.

7. WCD 322 contacts computer 342 to determine if the candidate container is container 302. For example, WCD 322 obtains identifier 314 and transmits identifier 314 to computer 330 for confirmation.

8. Computer 330 determines that the identifier transmitted by WCD 322 matches the identifier in memory 332 and WCD 322 is now paired with container 302.

9. WCD 322 downloads regimen 336 from computer 330 and stores the regimen and identifier 314 in memory 324.

10. WCD 322 receives data 340 and issues reminder signals as needed.
a. The reminders can be modified based on the proximity of WCD 322 to container 302.
b. Using regimen 336, processor 326 can describe a proper course of action when a dosage of medication 316 is missed. The information can be presented to the patient at the appropriate time.

11. Independent of WCD 322, container 302 is able to detect when the container is opened through the use of its onboard sensor(s) 308.

12. The time and date of the openings of container 302 (condition 352) are recorded in log 350.

13. Whenever WCD 322 is in range of container 302, container 302 is interrogated by WCD 322 to obtain log 358.

14. WCD 322 updates log 358 in memory 324 and WCD 322 can then correspondingly adjust behavior, for example creating and issuing instructions 362 or 368.

15. WCD 322 can transmit log 358 to computer 330 and computer 346 to keep interested parties updated.
a. Optionally, computer 330 can keep interested and authorized individuals informed of the patient's conformance with regimen 336.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based system for improving medication regimen adherence, comprising:
a first computer including:
a first memory element configured to store:
a first medication regimen including a first prescription for a first medication; and,
a first unique identifier associated with the first medication regimen; and,
a first processor;
a first container arranged to hold the first medication and including:
a first wireless transceiver; and,
the first unique identifier; and,
a first wireless communications device (WCD) including:
a second memory element; and,
a second processor configured to:
when the first container is within a first predetermined distance of the first WCD:
obtain, via the first wireless transceiver, the first unique identifier from the first container; and,
transmit, to the first computer, the first unique identifier obtained from the first container, wherein:
the first processor is configured to:
confirm that the first unique identifier from the first container matches the first unique identifier stored in the first memory element; and,
transmit the first medication regimen to the first WCD; and,
the second processor is configured to store the first medication regimen in the second memory element.

2. The computer-based system of claim 1, wherein the first computer is configured to obtain the first unique identifier and the first medication regimen from a second processor associated with an entity providing the first medication for the first container.

3. The computer-based system of claim 1, wherein the second processor is configured to:
obtain first data from the first container;
determine, according to the first data and the first medication regimen, that a first reminder to take the first medication is desired; and,
output a first sensory reminder signal.

4. The computer-based system of claim 3, wherein the first WCD is configured to transmit the first data to the first computer.

5. The computer-based system of claim 3, wherein the first computer is configured to transmit the first data to a second computer associated with a health care provider providing the first prescription.

6. The computer-based system of claim 3, wherein:
the first medication regimen includes a plurality of time frames within which to access the first container to obtain a first dosage of the first medication; and,
the second processor is configured to determine, according to the plurality of time frames, that the first reminder to take the first medication is desired.

7. The computer-based system of claim 3, wherein:
the first container includes a sensor configured to create second data identifying a condition associated with opening the first container; and,
the second data is included in the first data.

8. The computer-based system of claim 7 wherein:
the first container includes a third processor;
the sensor is configured to send a respective detection signal to the third processor for each detected occurrence of the condition;
the third processor is configured to create an access log including a respective time at which each respective detection signal is received by the third processor; and,
the first data includes the access log.

9. The computer-based system of claim 8 wherein:
the first medication regimen includes a plurality of time frames within which to access the first container to obtain a first dosage of the first medication; and,
the second processor is configured to;
determine, using the access log, that the first container has not been accessed within a first time frame included in the plurality of time frames;
create instructions to: take the first dosage within a second time frame; or, take the a second dosage, different from the first dosage, within a second time frame; and,
provide a first sensory display of the first instructions.

10. The computer-based system of claim 9 wherein the first WCD is configured to transmit a message, to the first computer, regarding creation of the instructions.

11. The computer-based system of claim 8 wherein:
the first medication regimen includes a plurality of time frames within which to access the first container to obtain a first dosage of the first medication; and,
the second processor is configured to;
determine that the first container is not within the first distance of the first WCD during a first time frame included in the plurality of time frames;
create first instructions to take an action selected from the group consisting of contacting a health care provider, modifying diet or physical activity, and modifying a second medical regimen for a second medication;
provide a first sensory display of the first instructions; and,
when the first container is within the first distance of the first WCD:
create second instructions to: take the first dosage within a second time frame; or, take the a second dosage, different from the first dosage, within a second time frame; and,
provide a second sensory display of the second instructions.

12. The computer-based system of claim 11 wherein the first WCD is configured to transmit a message, to the first computer, regarding creation of the first and second instructions.

13. The computer-based system of claim 1, wherein the first processor is configured to receive the first medication regimen from a second computer associated with a health care provider providing the first prescription.

14. The computer-based system of claim 1, wherein the first memory element is configured to store:
a second medication regimen including a second prescription for a second medication; and,
a second unique identifier associated with the second medication regimen, the system further comprising:
a second container arranged to hold the second medication and including:
a second wireless transceiver; and,
a second unique identifier, wherein:
the second processor configured to:
when the second container is within the first predetermined distance of the first WCD:
obtain, via the second wireless transceiver, the second unique identifier from the second container; and,
transmit, to the first computer, the second unique identifier obtained from the second container;
the first processor is configured to:
confirm that the second unique identifier from the container matches the second unique identifier stored in the first memory element; and,
when the second unique identifier from the second container matches the second unique identifier stored in the first memory element, transmit the second medication regimen to the first WCD; and,
the second processor is configured to store the second medication regimen in the second memory element.

15. The computer-based system of claim 1, further comprising:
a second WCD:
including a third memory element; and,
a third processor configured to:
when the first container is within the first predetermined distance of the second WCD:
obtain, via the first wireless transceiver, the first unique identifier from the first container; and,
transmit, to the first computer, the first unique identifier obtained from the first container, wherein:
the first processor is configured to:
confirm that the first unique identifier from the first container matches the first unique identifier stored in the first memory element; and,
transmit the first medication regimen to the second WCD; and,
the third processor is configured to store the first medication regimen in the third memory element.

16. A computer-based system for improving medication regimen adherence, comprising:
a container arranged to hold a first medication and including:
a wireless transceiver; and,
a unique identifier; and,
a wireless communications device (WCD) including:
a memory element configured to store:
a medication regimen including a prescription for the medication; and,
the unique identifier, the unique identifier associated with the medication regimen; and,
a processor configured to:
when the container is within a predetermined distance of the WCD:
obtain, via the wireless transceiver, the unique identifier from the container;
confirm that the unique identifier from the container matches the unique identifier stored in the memory element;
obtain data from the container regarding instances of the container being opened;
determine, according to the data and the medication regimen, that a reminder to take the medication is desired; and,
output a sensory reminder signal.

17. A container for improving medication regimen adherence, comprising:
a body portion arranged to store a medication;
a sensor configured to detect a condition associated with accessing contents of the body portion;
a wireless transceiver; and,
a processor configured to:
create data regarding identification of the condition; and,
when the container is within a predetermined distance of a specially programmed wireless communications device (WCD), transmit the data to the WCD.

18. The container of claim 17, further comprising:
a unique identifier, wherein the processor is configured to transmit, using the wireless transceiver, the globally unique identifier to the specially programmed WCD.

19. The container of claim 17, wherein:
the sensor is configured to detect each occurrence of the condition;
the processor is configured to create an access log including a respective time for said each occurrence; and,
the data includes the access log.

20. A wireless communications device (WCD) for improving medication regimen adherence, comprising:
a memory element; and,
a processor configured to:
when the WCD is within a predetermined distance of a container including a wireless transceiver receive, via the wireless transceiver, a unique identifier from the container;
transmit the unique identifier to a second computer;
receive, from the second computer, a medication regimen including a prescription for a medication; and,
store the medication regimen in the memory element.

21. The WCD of claim 20, wherein the processor is configured to:
obtain data from the container;
determine, according to the data and the medication regimen, that a reminder to take the medication is desired; and,
output a sensory reminder signal.

22. The WCD of claim 21, wherein the WCD is configured to transmit the data to the second computer.

23. The WCD of claim 21, wherein:
the medication regimen includes a plurality of time frames within which to access the container to obtain a dosage of the medication; and,
the processor is configured to determine, according to the plurality of time frames, that the reminder to take the medication is desired.

24. The WCD of claim 21, wherein the data includes an access log indentifying respective times associated with opening the container.

25. The WCD of claim 24, wherein:
the medication regimen includes a plurality of time frames within which to access the container to obtain a first dosage of the first medication; and,
the processor is configured to:
determine, using the access log, that the container has not been accessed within a first time frame included in the plurality of time frames;
create instructions to: take the first dosage within a second time frame; or, take the a second dosage, different from the first dosage, within a second time frame; and,
provide a sensory display of the instructions.

26. The WCD of claim 24, wherein:
the medication regimen includes a plurality of time frames within which to access the container to obtain a first dosage of the first medication; and,
the processor is configured to:
determine that the container is not within the distance of the WCD during a first time frame included in the plurality of time frames;
create first instructions to take an action selected from the group consisting of contacting a health care provider, modifying diet or physical activity, and modifying a second medical regimen for a second medication;
provide a first sensory display of the first instructions; and,
when the container is within the distance of the WCD:
create second instructions to: take the first dosage within a second time frame; or, take the a second dosage, different from the first dosage, within a second time frame; and,
provide a second sensory display of the second instructions.

27. A computer-based method for improving medication regimen adherence, comprising:
storing in a first memory element for a first computer:
a medication regimen including a prescription for a medication; and,
a unique identifier associated with the medication regimen;
when a container is within a predetermined distance of a wireless communications device (WCD):
obtain, using a first processor for the WCD and via a wireless transceiver for the container, the unique identifier from the container;
transmit, using the first processor, the unique identifier obtained from the container to the first computer;
confirming, using a second processor for the first computer, that the unique identifier from the container matches the unique identifier stored in the first memory element;
transmitting, using the second processor, the medication regimen to the WCD; and,
storing the medication regimen in the second memory element.

28. The computer-based method of claim 27, further comprising:
obtaining, using the first processor, data from the container;
determining, using the first processor and according to the data and the medication regimen, that a reminder to take the medication is desired; and,
outputting, using the first processor, a sensory reminder signal.

29. The computer-based method of claim 28, further comprising:
transmitting, to a third processor for the container and using a sensor for the container, a respective detection signal for each detected occurrence of a condition associated with opening the container;
creating, using the third processor, an access log including a respective time at which each respective detection signal is received by the third processor; and,
including the access log in the first data.

30. The computer-based method of claim 29, wherein the first medication regimen includes a plurality of time frames within which to access the first container to obtain a first dosage of the first medication, the method further comprising:
determining, using the first processor and the access log, that the first container has not been accessed within a first time frame included in the plurality of time frames;
creating, using the first processor, instructions to: take the first dosage within a second time frame; or, take the a second dosage, different from the first dosage, within a second time frame; and,
providing, using the first processor, a first sensory display of the first instructions.

31. The computer-based method of claim 29, wherein the first medication regimen includes a plurality of time frames within which to access the first container to obtain a first dosage of the first medication, the method further comprising:
determining, using the first processor, that the first container is not within the first distance of the first WCD during a first time frame included in the plurality of time frames;
creating, using the first processor, first instructions to take an action selected from the group consisting of contacting a health care provider, modifying diet or physical activity, and modifying a second medical regimen for a second medication;
providing, using the first processor, a first sensory display of the first instructions; and,
when the first container is within the first distance of the first WCD:
creating, using the first processor, second instructions to: take the first dosage within a second time frame; or, take the a second dosage, different from the first dosage, within a second time frame; and,
providing, using the first processor, a second sensory display of the second instructions.

32. A computer-based method for improving medication regimen adherence, comprising:
storing in a memory element of a wireless communications device (WCD):
a medication regimen including a prescription for the medication; and,
a unique identifier, the unique identifier associated with the medication regimen;
when the container is within a predetermined distance of the WCD:
obtaining, using a processor for the WCS and via the wireless transceiver, a unique identifier from the container;
confirming, using the processor, that the unique identifier from the container matches the unique identifier stored in the memory element;
obtaining, using the processor, data from the container regarding instances of the container being opened;
determining, using the processor and according to the data and the medication regimen, that a reminder to take the medication is desired; and,
outputting, using the processor, a sensory reminder signal.
